(19) United States
(12) Patent Application Publication
(10) Pub. No.: US 2002/0132715 A1
(43) Pub. Date: Sep. 19, 2002

(54) Universal box maker

(76) Inventor: Martin R. Carbone, Santa Barbara, CA (US)

Correspondence Address: CHRISTIE, PARKER & HALE, LLP, 350 WEST COLORADO BOULEVARD, SUITE 500, PASADENA, CA, 91105, US

(21) Appl. No.: 09/811,005

(22) Filed: Mar. 16, 2001

(51) Int. Cl. B31B 49/00

(52) U.S. Cl. 493/51

(57) ABSTRACT

A universal boxmaker with a rectangular flat plate with apertures formed thereon, and a guide rail. The flat plate has a top surface, a front edge, a rear edge, two side edges, and a plurality of spaced apart apertures having a predetermined size. The apertures are formed in the top surface of the flat plate and spaced apart by uniform increments from each other. The guide rail has a bottom surface, a front wall, a rear wall, and a protrusion extending from the bottom surface. The protrusion is sized to detachably engage in the apertures formed in the flat plate. To accommodate the making of telescoping boxes, the distance between a centerline of the protrusion and the front wall, and the centerline of the protrusion and the rear wall are different.

### BACKGROUND OF THE INVENTION (FIELD OF THE INVENTION)

This invention is related to box making devices, and more particularly a box making device for making boxes of corrugated and other materials.

### BACKGROUND OF THE INVENTION (DISCUSSION OF THE ART)

The inventor has invented numerous box making devices, including U.S. Pat. Nos. 5,484,373 for “Kit for making boxes and method for using”, 5,707,327 for “Box making kit and method for using”, and 5,855,543 for “Box making device and method for using”. The inventor has also invented cardboard that is preprinted or pre-scored in a novel grid pattern, which sheet material can be bent along the print lines or score lines to form a box.

Boxes or cartons are traditionally made from a semi-rigid cardboard stock and corrugated cardboard by first cutting a cardboard blank to the desired dimensions of the outer walls and flaps. The cardboard blanks are then scored on fold lines and the scored fold lines are notched between the various flaps so that the top or bottom of the box or container may be folded. Such box making equipment usually employs a scoring and slotting machine which is adaptable for producing boxes in a variety of sizes. Such a machine is expensive and not normally available for individual use. It is, therefore, desirable to produce a versatile system for making boxes whereby one or more custom boxes may be inexpensively made by any individual at his/her home or place of work. The inventor's prior box making kits and methods of the above noted U.S. patents are unique in that they allow a user to make boxes out of card stock into a great number of sizes and depths. However, these kits require a scoring tool and spacers, and may not be applicable to corrugated cardboard. There accordingly remains a need for a box making device adapted for use in making corrugated cardboard boxes that is inexpensive and easy to use.

### SUMMARY OF THE INVENTION

A first embodiment of the box making device has the following features:

(1) A preferably flat plate of a desired size, e.g. 70 cm long×91.4 cm wide×1.9 cm thick or 91.4 cm×121.9 cm wide by 1.9 cm thick, (24″ long×36″ wide×¾″ thick) with square edges on at least the top edges of longer sides of the plate;

(2) Two identical rows of locating holes, slots, or apertures (“locating apertures”) each row parallel to the short side, e.g. 70 cm (24″) of the flat plate, e.g. left set and right set of apertures.

(3) The locating apertures being spaced in uniform increments (e.g. 2.5 cm (1″) increments) from one of the long sides (36″ side edge) of the flat plate, which will be referred to as the front edge of the flat plate. The other long side (91.4 cm (36″) side edge) is referred to as the back edge of the flat plate. The pairs of apertures are a predetermined distance apart (e.g. 76.2 cm (30″) apart) and are a predetermined distance away from the short side edges (e.g. 7.6 cm (3″).)

(4) A movable guide rail that is preferably as long as the long side of the flat plate (e.g. 91.4 cm (36″) long), having a thickness (e.g. 1.9 cm (¾″)), and a width (e.g. 4.4 cm (1-¾″))with a flat bottom side.

(5) Two protrusions extend from the bottom side of the guide rail. The two protrusions are sized to matingly fit into pairs of apertures in the flat plate (e.g. placed 7.6 cm (3″) from the two ends of the movable guide rail, protrusions) and are preferably centered at 2.5 cm (1″) from the front face and a different distance (e.g. 1.9 cm (¾″)) from the second face.

In a second embodiment of the invention, similar to the first embodiment, instead of rows of locating holes, rows of parallel, spaced apart locating slots will be formed on the plate and will extend across either the entire width of the plate, or a substantial percentage of the width of the plate. These locating slots will be spaced in uniform increments (e.g. 2.5 cm (1″) increments) from one of the long sides (36″ side edge) of the flat plate, which will be referred to as the front edge of the flat plate. The other long side (91.4 cm (36″) side edge) is referred to as the back edge of the flat plate.

As with the first embodiment, there will be a movable guide rail that is preferably as long as the long side of the flat plate (e.g. 91.4 cm (36″) long), having a thickness (e.g. 1.9 cm (¾″)), and a width (e.g. 4.4 cm (1¾″)) with a flat bottom side.

At least one protrusion extends from the bottom side of the guide rail. The at least one protrusion is sized to matingly fit into a locating slot in the flat plate and is preferably centered at 2.5 cm (1″) from the front face and a different distance (e.g. 1.9 cm (¾″)) from the second face. The protrusion can extend the entire width of the guide rail, a portion of the width, or a plurality of protrusions can extend from the bottom of the guide rail.

### BRIEF DESCRIPTION OF THE DRAWINGS

FIG. 1 is a top plan view of the flat plate of the first embodiment of the box maker of the invention with pairs of apertures formed therein.

FIG. 2 is an isometric view showing part of the flat plate of FIG. 1 with a guide rail placed thereon.

FIG. 3 is an isometric view of the guide rail.

FIG. 4 is a top plan view of the flat plate with the guide rail placed in a first orientation with a front face facing a front edge of the flat plate.

FIG. 5 is a top plan view of the flat plate with the guide rail placed in a second orientation with a rear face facing a front edge of the flat plate.

FIG. 6 is a side view of FIG. 4 through view lines 6-6.

FIG. 7 is a side view of FIG. 5 through view lines 7-7.

FIG. 8 is a top plane view of the flat plate of the second embodiment of the box maker of the invention.

FIG. 9 is an isometric view of a second embodiment of a guide rail for use with the second embodiment of the flat plate.

### DETAILED DESCRIPTION OF THE INVENTION

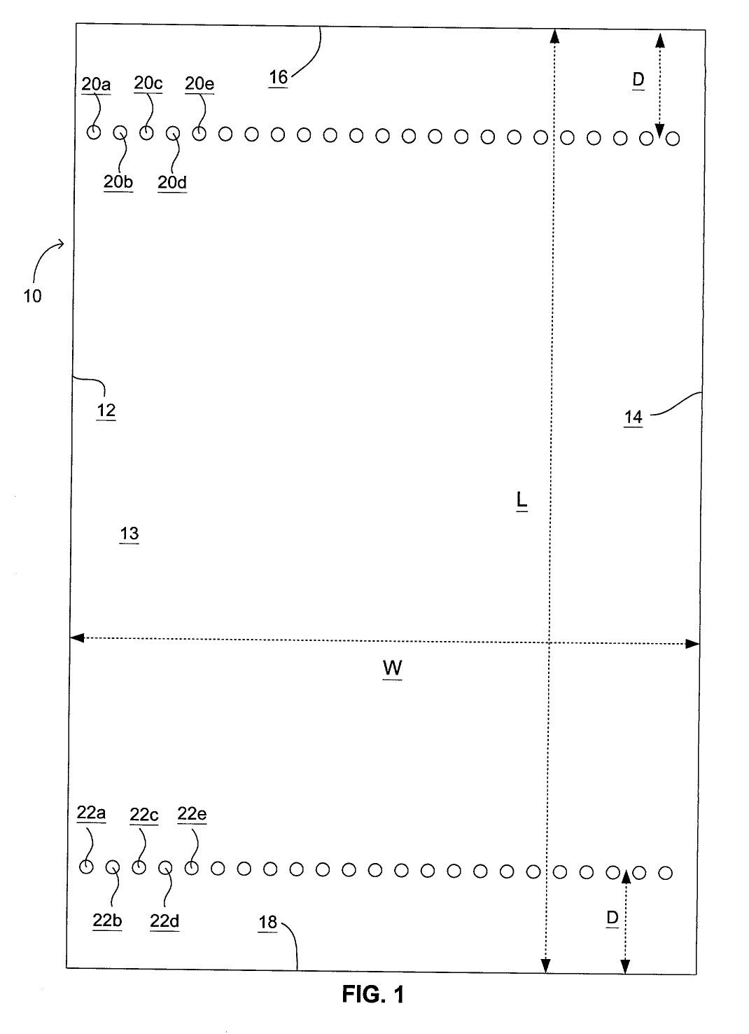

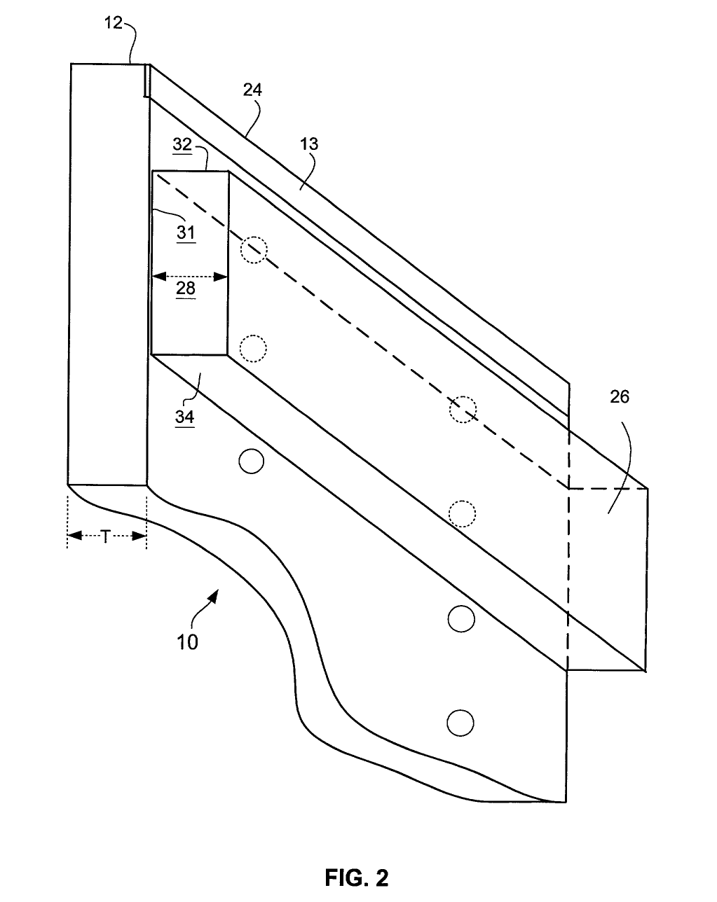

Referring to FIG. 1, a flat plate 10 of the first embodiment of the invention is shown. It has a front edge 12, a rear edge 14, and two side edges 16 and 18. The front and rear edge should be relatively sharp, with no radius at the end. A plurality of pairs of apertures 20a and 22a, 20b and 22b, 20c and 22c, etc. are formed on top of the flat plate 10, and are parallel to side edges 16 and 18 of the flat plate 10 and are preferably spaced an even distance therefrom (“D”.) The pairs of apertures are preferably spaced apart in even increments away from the front edge 12 (e.g. 1″ increments.) The flat plate 10 has a length “L”, width “W”, and thickness “T” (e.g. 24″ long×36″ wide×¾″ thick) with square edges 24 (see FIG. 2) on at least the top edges of longer side edges 12 and 14 of the plate.

Referring to FIG. 2, there is shown a movable guide rail 26 attached to flat plate 10. Movable guide rail 26 is preferably as long as the long side edges 12 and 14 of the flat plate 10 (e.g. 91.4 cm (36″) long), has a thickness 28 (e.g. 1.9 cm (¾″)), and a width 30 (e.g. 4.4 cm (1¾″)) with a flat bottom surface 31. Movable guide rail 26 has a first vertical face 32 and a second vertical face 34, both of which are preferably flat and perpendicular to the flat bottom surface 31. For sturdiness, front and rear edges 12 and 14 can have a metal (or other durable material) strip 13 attached thereto.

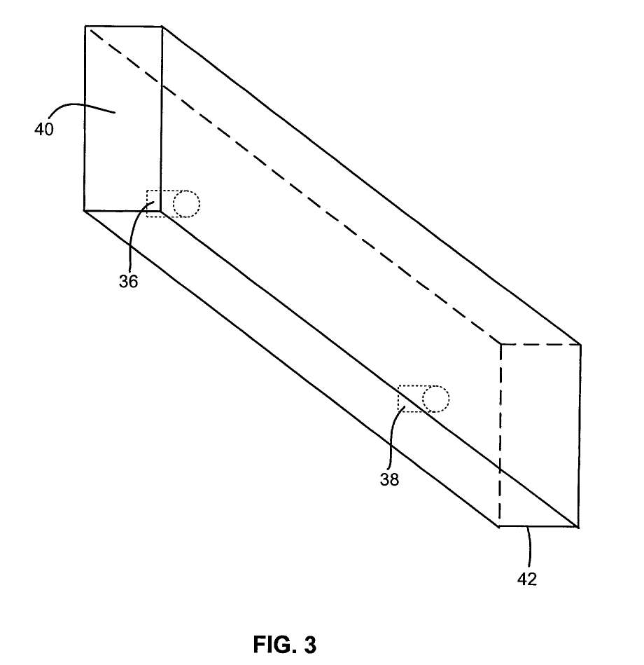

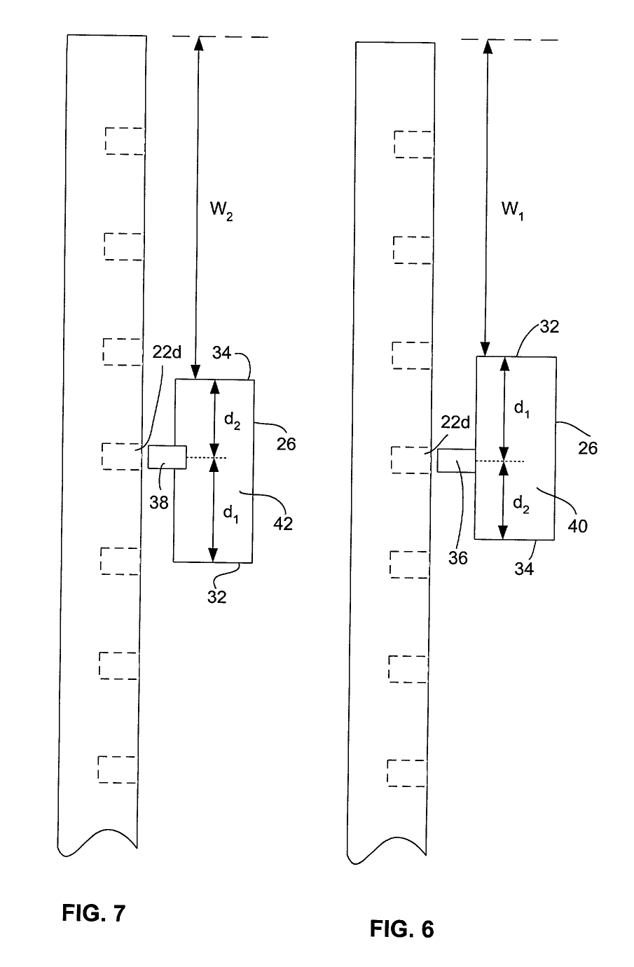

Turning to FIGS. 3, 6 and 7, there are shown protrusions 36 and 38 extending from the bottom surface 30 of the guide rail 26 near opposite ends 40 and 42, respectively, of the guide rail 26. As can be best seen if FIGS. 6 and 7, the centerlines of protrusions 36 and 38 are positioned a distance d₁ (e.g. 2.5 cm (1″)) from front edge 32 of guide rail 26 and a different distance d₂ (e.g. 1.9 cm (¾″)) from rear edge 34 of guide rail 16. The two protrusions 36 and 38 are sized to snugly fit into any two pairs of apertures 20a and 22a, 20b and 22b, 20c and 22c, etc., in flat plate 10.

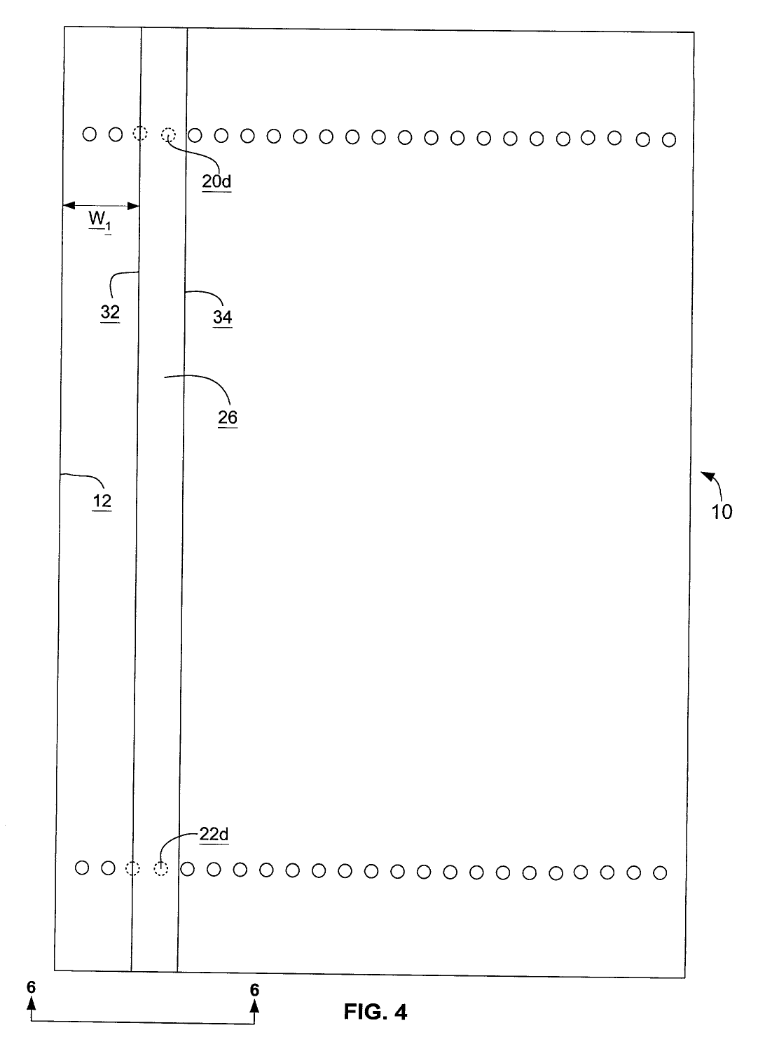

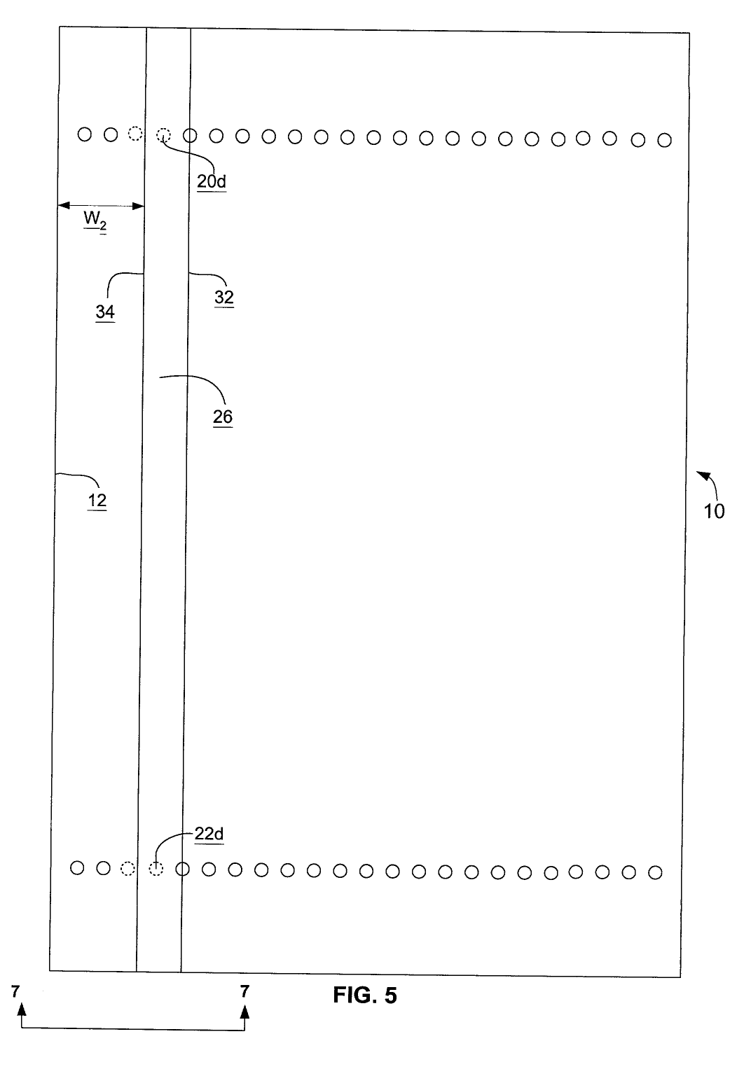

As shown in FIGS. 4 and 6, when guide rail 26 is positioned on flat plate 10 with its first vertical face 32 facing toward front edge 12 of flat plate 10 and with its protrusions in apertures 20d and 22d, the distance between first vertical face 32 and front edge 12 of flat plate 10 is distance W₁ 7.6 cm( 3″), but, as shown in FIGS. 5 and 7, when guide rail 26 is rotated by 180° and is positioned on flat plate 10 with its second vertical face 34 facing toward front edge 12 of flat plate, the distance between the second vertical face 32 and the front edge 12 of flat plate 10 is distance W₂ 8.3 cm (3¼″.)

The method of using the first embodiment of box making device is now described. When movable guide rail 26 is placed in any pair of apertures 20a and 22a, 20b and 22b, 20c and 22c, etc., with its first vertical face 32 of guide rail 26 facing front edge 12, distance W, facing front edge will therefor be an full number of units (e.g. inches or metric equivalents) from front edge 12 of the flat plate. For increment units of 2.5 cm (1″), FIG. 4 shows guide rail 26 setup with its first vertical face 32 spaced a distance W₁ 7.6 cm (3″) from front edge 12 of flat plate 10 and with its protrusions inserted into apertures 20d and 22d.

If guide rail 26 is now turned 180° in the horizontal plane and inserted in the same pair of apertures 20d and 22d, such that second vertical face 34 of guide rail 26 is facing front edge 12 of flat plate 10, distance W₂ from second vertical face 34 of guide rail 26 to front edge 12 of flat plate 10 will be 8.3 cm (3¼″), as shown in FIG. 5. If inserted into other pairs of apertures, second vertical face 34 of guide rail 26 will be 3.2 cm, 5.7 cm, 8.3 cm . . . 59.4 cm (1¼″, 2¼″, 3¼″, . . . 23¼″) from front edge 12.

An example of the method of using the box making device will be described with reference to making a telescoping box with dimensions 35.6 cm×50.8 cm×5.1 cm (14″×20″×2″) from 0.3 cm (⅛″) thick corrugated cardboard.

1. Two identical pieces of corrugated cardboard sizes 47.7 cm×61.0 cm(18″×24″) would be selected or cut to size.

2. Guide rail 26 would be positioned so first face 32 of guide rail 26 would face front edge 12 of flat plate 10 and would be 5.1 cm (2″) from front edge 12.

3. One of the two pieces of 47.7 cm×61.0 cm (18″×24″) cardboard is place on the flat plate with its side edges placed against guide rail 26 with the rest of the piece extending outwardly from front edge 12 of flat plate 10. Thereafter, the user will crush-score and fold down the piece of cardboard along the sharp front edge 12 preferably with the palms of the users hands pressing the cardboard against the edge, thereby forming a sharp fold line in the cardboard. The user will do this to all four sides of the piece of cardboard, and then cut a notch in the corners. This piece of cardboard would be folded and its corners affixed together (e.g. with glue, tape, staples, etc.) as described in U.S. Pat. No. 5,484,373 and would become a larger top of a telescoping box. No marking or measuring would be required.

4. Guide rail 26 would be turned 180 degrees in the horizontal plane and positioned so second vertical face 34 of guide rail 34 is 5.7 cm (2¼″) from front edge 12 of flat plate 10.

5. The second of the two pieces of 47.7 cm×61.0 cm (18″×24″) cardboard would be crush-scored and cut as described in step 3. This piece would be folded and attached together and would become the bottom of the telescoping box.

In addition, the slots can be used exactly as the scoring slots in the inventor's previous inventions as enumerated under the heading “BACKGROUND OF THE INVENTION.”

6. The top of the box will fit in a mating fashion with the bottom because of the difference in spacing of guide rail to front edge of the plate. The principle that enables this mating fit is very much like the principle behind the inventor's U.S. Pat. No. 5,484,373 in that a vertical locating edge is used to set the depth of the box being made. However, in this case, there is no scoring tool, and the folds are facilitated by crush scoring.

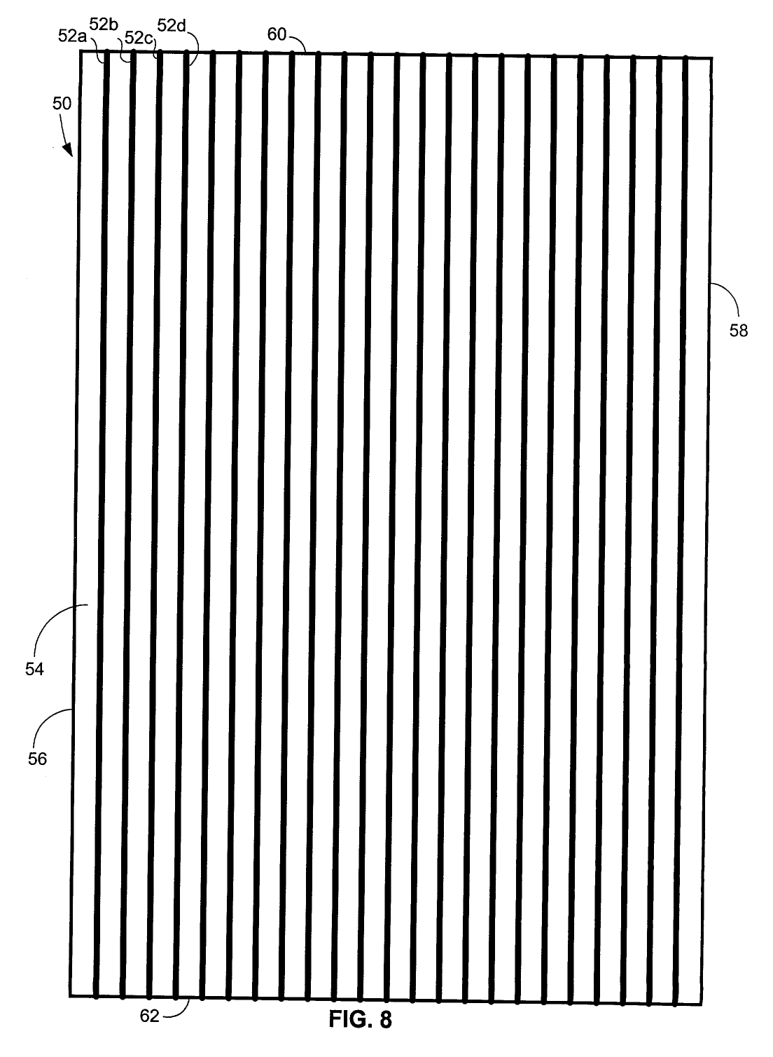

Turning next to FIG. 8, there is shown a top plan view of a second embodiment of the flat plate 50. Unlike the flat plate of the first embodiment 10, flat plate has a plurality of parallel and evenly spaced apart slots 52a, 52b, 52c, 52d, 52e, etc. formed on its top surface 54. The slots are parallel to the front edge 56 and rear edge 58 and perpendicular to side edges 60 and 62. Each slot 52a, 52b, 52c, 52d, 52e, etc. has a slot width. As shown in FIG. 8, the slots can extend across the entire width W of the plate 50, or can extend partially thereacross (not shown).

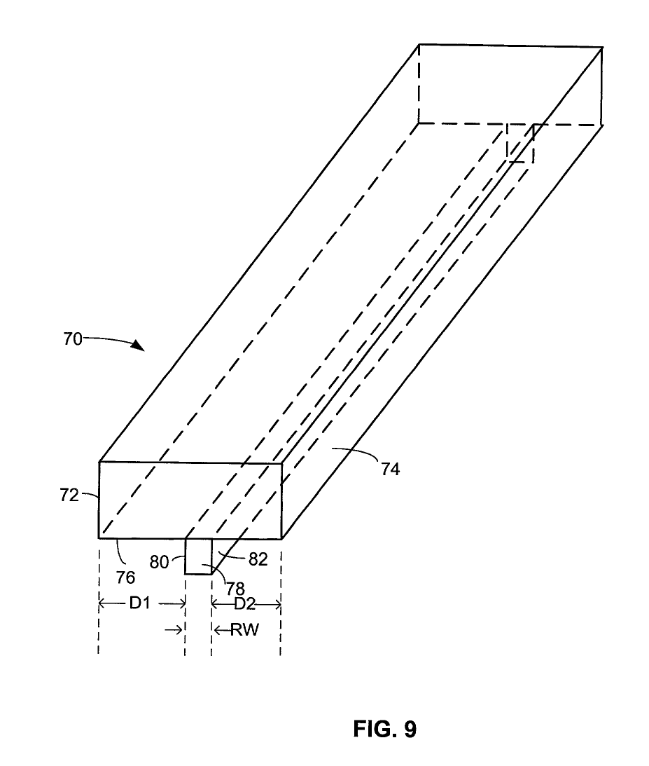

Turning to FIG. 9, an isometric view of a movable guide rail 70 is shown. The guide rail 70 has a first face 72, a second face 74, a bottom 76, and a foot 78 extending downwardly from bottom 76. Foot 78 has a width “RW” which is sized so that foot will snugly fit into the slots 52a, 52b, 52c, etc. of the flat plate 50. The distance between a first face 80 of the foot and the first face 72 of guide rail is D₁, and the distance between a second face 82 of foot and second face 74 is D, with D₁ preferably being different than D₂.

Guide rail 70 can be engaged with flat plate 50 by sliding foot 80 into any of the slots 52a, b, c, d, etc. of flat face 50, and with either the first face 72 or second face 74 of rail 70 facing front edge 56 of the flat plate 50. The second embodiment can be used in the same manner as the first embodiment as desired above.

The following additional modifications can be made as well.

1. If flat plates 10 or 50 are sized down from a 61.0 cm (24″) width to a 23½″ width, guide rails 26 or 70 can be positioned to be 3.8 cm, 6.4 cm, 8.9 cm . . . (1½″, 2½″, 3½. . . 23½″) and 4.4 cm, 7.0 cm, 9.5 cm, 60.3 cm (1¾″, 2¾″, 3¾. . . 23¾″) from the rear edge 14 of the flat plate 10, thus enabling the operator to make boxes in 1.3 cm (½″) increments. Likewise, if flat plates 10 or 50 are sized down from a 61.0 cm (24″) width to a 59.7 cm (23-½″) width, but the apertures (or slots) are spaced in 2.5 cm (1″) increments from the front edge, then the box making device can be used to make boxes in either 2.5 cm (1″) size increments (by using the front edge for crush scoring the cardboard), or in 1.3 cm (½″) increments (by using the rear side as the crushing edge.)

3. If it is desired to make boxes with thinner or thicker corrugated cardboard, the width of guide rails can be changed such that it will automatically cause the difference in rail-to-edge spacing to match the difference needed for that particular thickness of cardstock. Thus one plate can be used for different corrugated thicknesses if different width rails are provided.

4. This same principle will also function with flat non-corrugated cardstock if the plate edge is very sharp or slightly serrated and if a hard tool is used to press or roll the cardstock against the edge.

5. While both embodiments of the universal box maker of the invention have been described as having even English units, the box maker can be sized to have even units of spacing in metric units, e.g. full centimeters.

The drawings and the foregoing description are not intended to represent the only form of the invention in regard to the details of this construction and manner of operation. In fact, it will be evident to one skilled in the art that modifications and variations may be made without departing from the spirit and scope of the invention. Although specific terms have been employed, they are intended in a generic and descriptive sense only and not for the purpose of limitation.

1. A universal box maker, comprising:
a plate with a top surface, a front edge, a rear edge, and two side edges, and a plurality of spaced apart apertures having a predetermined size, the apertures being formed in the top surface of the plate, the apertures being spaced apart by predetermined units; and
a guide rail having a bottom surface and a front wall, and a protrusion extending from the bottom surface, the protrusion being sized to detachably engage in the apertures formed in the plate.

2. The universal box maker of claim 1, wherein the apertures are spaced apart by uniform increments from each other.

3. The universal box maker of claim 2, wherein the apertures are parallel to each other and to the front and rear edges of the plate and the apertures comprise elongate slots having a width, and wherein the protrusion is sized to fit into the elongate slots.

4. The universal box maker of claim 3, wherein the protrusion comprises an elongate foot.

5. The universal box maker of claim 3, wherein the elongate slots extend from side edge to side edge of the plate.

6. The universal box maker of claim 1, wherein the apertures comprise two columns of spaced apart apertures, each column being parallel to and evenly spaced away from each of the two side edges of the plate and from the other column, and wherein the guide rail has two protrusion that are spaced apart by the same distance as the two columns of apertures.

7. The universal box maker of claim 6, wherein the apertures in each column are spaced apart by uniform increments from each other.

8. The universal box maker of claim 1, wherein the guide rail further comprises a rear wall, and the distances between a centerline of the protrusion and the front wall, and the centerline of the protrusion and the rear wall, are different.

9. The universal box maker of claim 1, wherein the distance between the aperture closest to the front edge of the plate and the front edge of the plate is the same as the distance between the aperture closest to the rear edge of the plate and the rear edge of the plate.

10. The universal box maker of claim 1, wherein the distance between the aperture closest to the front edge of the plate and the front edge of the plate is different from the distance between the aperture closest to the rear edge of the plate and the rear edge of the plate.

11. The universal box maker of claim 1, wherein the front and rear edges are sharp.

12. A universal box maker, comprising:
a rectangular, flat plate with a top surface, a front edge, a rear edge, and two side edges, and a plurality of spaced apart apertures having a predetermined size, the apertures being formed in the top surface of the flat plate and spaced apart by uniform increments from each other; and
a guide rail having a bottom surface, a front wall, a rear wall, and a protrusion extending from the bottom surface, the protrusion being sized to detachably engage in the apertures formed in the flat plate.

13. The universal box maker of claim 12, wherein the apertures are parallel to each other and to the front and rear edges of the plate and the apertures comprise elongate slots having a width, and wherein the protrusion is sized to fit into the elongate slots.

14. The universal box maker of claim 13, wherein the protrusion comprises an elongate foot.

15. The universal box maker of claim 12, wherein the apertures comprise two columns of spaced apart apertures, each column each being parallel to and evenly spaced away from each of the two side edges of the plate and from the other column, and wherein the guide rail has two protrusion that are spaced apart by the same distance as the two columns of apertures.

16. The universal box maker of claim 12, wherein the distances between a centerline of the protrusion and the front wall, and the centerline of the protrusion and the rear wall, are different.

17. The universal box maker of claim 12, wherein the distance between the aperture closest to the front edge of the plate and the front edge of the plate is the same as the distance between the aperture closest to the rear edge of the plate and the rear edge of the plate.

18. The universal box maker of claim 12, wherein the distance between the aperture closest to the front edge of the plate and the front edge of the plate is different from the distance between the aperture closest to the rear edge of the plate and the rear edge of the plate.

19. The universal box maker of claim 12, wherein the front and rear edges are sharp.
